(19) United States
(12) Patent Application Publication
(10) Pub. No.: US 2008/0041197 A1
(43) Pub. Date: Feb. 21, 2008

(54) MECHANICALLY LEVERAGED KEY RING OPENER

(76) Inventor: JANET LYNN LALOND, Lake Zurich, IL (US)

Correspondence Address: FEMAL & ASSOCIATES, 812 N. BELMONT AVE., ARLINGTON HEIGHTS, IL, 60004-5606, US

(21) Appl. No.: 11/465,867

(22) Filed: Aug. 21, 2006

(51) Int. Cl. B25B 25/00; B25B 11/00

(52) U.S. Cl. 81/485; 29/229

(57) ABSTRACT

A mechanically levered spring coil key ring opener in which the thumb and fore finger digit operating the levered opener are generally protected from coming into contact with the spring coil key ring capable of breaking fingernails and cutting the operators digits on the hand or the hand itself. The levered key ring opener is spring loaded in the open position ready to insert the points of the prongs between the spring coil ring strips and with the minor thumb and fore finger pressure, the leverage is sufficient to create an opening between adjacent coil ring strips of the key ring to insert or remove a key of most thicknesses.

### BACKGROUND OF THE INVENTION

1. Field of the Invention

The present invention relates to a mechanically leveraged key ring opener and more particularly, to a key ring opener that generally protects the operators digits and hand while engaging the typical spring coil key ring.

Nearly ever person who has every attempted to open a spring coil key ring with various prior art key ring opening tools or substitute tools like a finger nail file eventually runs into the same problem of nicking a digit, thumb or hand with the sharp end of the circular spring coil key ring while inserting keys of various thicknesses. This potential injury of a digit, thumb or hand especially happens when a person is in a hurry to remove or attach house keys and the like to a spring coil key ring when leaving or picking up their car with a valet, car dealer, garage mechanic or other car attendant. The chance of engaging the sharp ends of a typical spring coil key ring causing a broken fingernail or other injury when spreading the adjacent coils of the key ring to manipulate a key in a hurried situation is greatly increased by the prior art devices.

Moreover, service professionals at various commercial establishments who need to attach or remove numerous customer car and other keys from a spring coil key ring throughout a days work need an opener that is easy to work but yet keeps their digits, thumbs and hands from abrasions, lost finger nails and further potential injury.

In addition, most car owners use the spring coil key rings to secure a host of keys on the ring, which interfere with the connection and disconnection of keys from the key ring. Fumbling with a number of keys on the typical spring coil ring while attempting to force open the key ring coils to insert or remove a key takes a considerable amount of force which is often difficult and frustrating to get the right leverage to open the coils of the key ring sufficiently and effortlessly for the insertion or removal of the chosen key. In fact, most keys themselves make a terrible wedge to open the spring coil key rings of today and almost always end up in the loss of a finger nail or worse while attempting to start a key insertion at one of the spring coil ends.

2. Prior Art

There are a number of mechanical key ring tools disclosed in various issued patents but they are insufficient often times to get the right mechanical leverage to open a crowded spring coil key ring. Examples of such prior art key ring openers can be found in U.S. Pat. No. 6,092,405 to Berwick; U.S. Pat. No. 5,373,717 to Gore et al; U.S. Pat. No. 4,719,778 to Murphy et al; U.S. Pat. No. 4,706,477 to Rousseau; U.S. Pat. No. 4,325,273 to Gibbons and GB 2,175,532 to Van Meter. Each of the patents however, lack sufficient leverage on large key rings to separate the spring coils of the key ring to insert or remove the selected key and still insure that a digit, thumb or hand will not engage the sharp end of the spring coil when the tool slips or the sharp end touches the operator while inserting the tool itself.

Some of these prior art tools are either attached or retained on the key ring itself which leaves their sharp tool protrusions like those found in the Gibbons or the elongated polygonal wedge shaped member found in Berwick that open the opposing coils of the key ring to engage and damage clothing material in a pocket or jab a person in the leg or worse when sitting down while these opening devices are attached to the key rings and stored in various clothing pockets.

It is an object of the present invention to avoid one or more of the disadvantages of the prior art and to provide a mechanically leveraged spring coil key ring opener that maximizes the leverage applied anywhere along the circumference of the key ring yet is simple and convenient to use without exposing the hands, thumbs or digits to unnecessary risk of injury.

### SUMMARY OF THE INVENTION

The present invention provides a mechanically leveraged key ring opener that allows the operator to apply maximum force between the spring coils anywhere around the circumference of a typical spring coil key ring and especially at either one of the spring coil ends to easily spread apart the end of the coil from the adjacent coil for the insertion and removal of hard to get at keys anywhere on the key ring circumference even when the key ring is essentially full of keys without risking injury to a thumb, digit or hand during the operation.

A mechanically leveraged key ring opener of the present invention is generally comprised of two essentially identical opposing members, each member having a generally oblong shape of a predetermined length, width and thickness that terminates at one end in a hooked prong with a generally rounded nose at its point that is spaced apart from the rounded nose on the other member a predetermined distance, and each member having the other end of its oblong shape joined to the other member in an affixed and rotatably connection thereto including a spring affixed to each member at the connected ends of the member to force apart the respective noses of the members the predetermined distance such that each nose swings in an arc toward and pass one another in a generally close adjacent relationship to each other to engage between two adjacent circumference lengths of a spring coil key ring on the inner and outer circumferences thereof to split the coils axially apart from one another for the insertion and removal of keys in a leveraged manner without any great force being applied by the thumb and forefinger of the operator on the backside of the opposing noses on each member. A surface either integrally or separately attached in a generally perpendicular relationship to the backside of each nose forming opposing platforms for placing at least one digit on the surface of one platform and a thumb on the other platform to rotate the noses in an arc toward one another to engage the opposite sides or circumferences of two adjacent spring coil rings on the key ring and driving the coiled rings axially apart up to a predetermined distance as the noses pass one another to a predetermined point in their travel in which the adjacent coils move apart axially as the coils travel up the curved underside of each nose away from one another. The opposing noses swinging in the arc toward one another allows an easy thumb and finger pressure on the opposing platforms behind each nose to place a leveraged pressure on axially separating adjacent coil rings of the spring coil key ring. The lever action of opposing noses is not accomplished by any prior art tools which essentially jam a single wedge or point between adjacent coil rings to axially move the coil rings apart in order to insert or remove a key from the key ring.

Moreover, the finger and thumb opposing and perpendicular to the nose platforms provide a shield or guard against the two ends of a typical spring coil key ring coming into contact with the hands, fingers or thumbs of the end user or operator of the opener.

In addition, if there are many keys on the key ring, the opener can be applied anywhere along the circumference of the key ring to provide a space between adjacent coils to slide the selected key easily along toward the end of the coil to remove the key. On crowded key rings with many different keys secured thereon, this is a particular helpful feature of the present invention. On many of the prior art ring key openers, the wedge or point needs to engage near or at the end of one spring coil adjacent the other in order to begin the axial separation of the adjacent coils. Still other opener tools of the prior art had to be flipped around to change directions before connecting or disconnecting a key while the present invention allows for the one simple arcing movement of the opposing noses to accomplish the task of connecting or disconnecting the keys from the coil ring.

In another aspect, the present invention provides a sloping inner surface of each nose for one of the adjacent spring coil rings or strips to slide up on the inner portion of each nose and separate axially from the other adjacent coil ring strip that remains essentially in place sliding along the outer surface of the noses as the ends of the opposing nose closely pass by one another to there final resting position and separation distance of each coil ring from the other for the insertion or removal of key. Again, the gradually increasing slope of the underside of each nose in a generally triangular shape provides easier finger pressure forces and leverage to accomplish the splitting apart of tighter and stiffer adjacent spring coil ring strips in larger key ring chains. So the present invention makes it easier for the end user to open tighter coil spring key ring chains without worrying about losing a finger nail or injuring a hand during the key insertion or removal operation.

Commercial businesses or establishments that handle hundreds of car spring coil rings per day will find it much easier to detach house keys for the owner when they are seeking work to be done on their cars at car dealers and garage repair centers. On the other hand, individuals parking their cars in lots were you must leave your car keys with the parking attendant or handing the car keys over to a valet can now easily remove their household and business keys for safety reasons from the spring coil key ring without any undue effort.

Other features and advantages of the invention, which are believed to be novel and nonobvious, will be apparent from the following specification taken in conjunction with the accompanying drawings in which there is shown a preferred embodiment of the invention. Reference is made to the claims for interpreting the full scope of the invention, which is not necessarily represented by any one embodiment.

### BRIEF DESCRIPTION OF THE DRAWINGS

FIG. 1 shows an overall perspective view of a mechanically leveraged coil key ring opener incorporating the basic components in accordance with the present invention being actuated by the end user with a digit and thumb on opposing platforms;

FIG. 2 is a partial perspective view of the key ring opener axially spreading the spring coil ring strips of a key ring to remove or insert a key onto the key ring without the digits and thumb on the opposing platforms of FIG. 1 showing a key about to be inserted;

FIG. 3 is a partial perspective view of the key ring opener according to the present invention wherein the key ring opener separates the spring coil ring strips and a key is inserted on a leg of the spring coil of FIG. 1;

FIG. 4 is a partial perspective view taken along lines 4-4 of FIG. 3 showing a key being removed from a coil on the key ring of FIG. 1;

FIG. 5 is a partial side view of opposing prongs on the key ring opener showing the arc of travel of the key ring opener of FIG. 1;

FIG. 6 is a perspective view of another embodiment of the key ring opener in accordance with the invention showing a digit and thumb operating the arc movement of the opposing prongs;

FIG. 7 is a partial perspective view of the key ring opener of FIG. 6 axially spreading the spring coil ring strips of the key ring for inserting or removing a key in accordance with the embodiments of FIG. 6;

FIG. 8 is a perspective view of yet another embodiment of the key ring opener showing a digit and thumb operating the arcing movement of the opposing prongs in accordance with the invention;

FIG. 9 is a perspective view of still another embodiment of the key ring opener in accordance with the present invention; and

FIG. 10 is a perspective view of still yet another embodiment of the key ring opener in accordance with the present invention.

### DETAILED DESCRIPTION

Although this invention is susceptible to embodiments of many different forms, a preferred embodiment will be described and illustrated in detail herein. The present disclosure exemplifies the principles of the invention and is not to be considered a limit to the broader aspects of the invention to the particular embodiment as described.

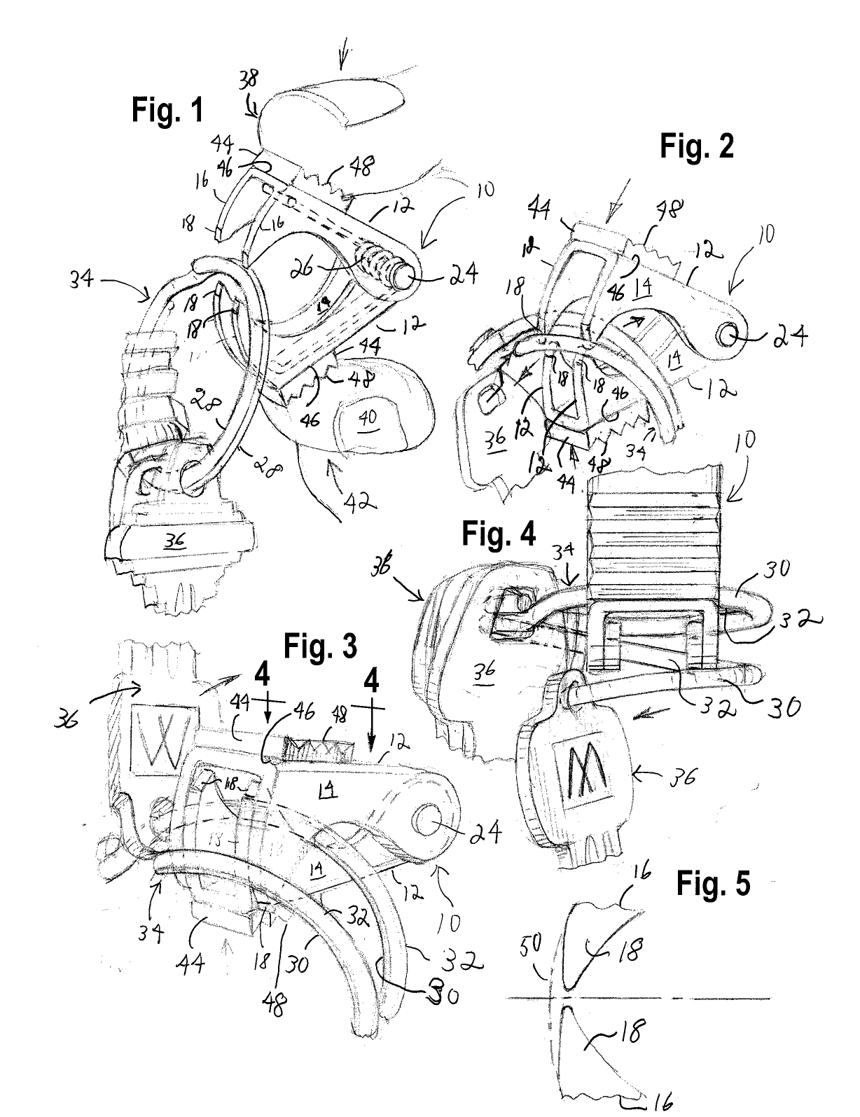

Referring now to the drawings and especially to FIGS. 1-4, 6-7 and 8-10, all show a mechanically leveraged spring coil key ring opener 10 having more than one embodiment in keeping with the invention. The mechanically leveraged key ring opener 10 of the present invention is generally comprised of at least two essentially identical opposing members 12, each member 12 having a generally oblong shape 14 of a predetermined length, width and thickness that terminates at one end in a hooked prong or jaw 16 ending with a generally rounded nose 18 having an end point 20 that is spaced apart from the rounded nose 18 on the other member 12 a predetermined distance, and each member 12 having the other end 22 of its oblong shape 14 joined to the other member by pin 24 or the like in an affixed and rotatably connection thereto including a spring 26 affixed to the pivot pin 24 and to each member 12 at the connected ends 22 of the members 12 to force apart the respective noses 18 of the members 12 the predetermined distance such that the noses 18 swing in an arc toward and pass one another in a generally a close juxtapose relationship to each other to engage between adjacent spring coil ring strips 28 on an inner 30 and an outer 32 circumference of a coil key ring 34 to split the adjacent coil ring strips 28 axially apart for insertion and removal of keys 36 in a leveraged manner without any great force being applied by a thumb 38 and at least one finger or digit 40 of an operator's hand 42 on the backside of the opposing noses 18 on each member 12 as shown in FIGS. 1, 2 and 6-10. A pair of generally identical surfaces 44 either integrally or separately attached in a generally perpendicular relationship to the backside 46 of each prong 16 and nose 18 forming opposing platforms 48 for placing at least one digit 40 on the surface of one platform and the thumb 38 on the other platform 48 to rotate the noses 18 of each prong 16 in an arc 50 toward one another to engage the opposite sides or circumferences 30 and 32 of two adjacent spring coil ring strips 28 on a key ring 34 driving the coils axially apart up to a predetermined distance as the noses 18 pass one another to a predetermined point in their travel in which the adjacent coil ring strips 28 move axially apart from one another as one of the coil ring strips 28 travel up the curved underside of each nose 18 away from the essentially stationary coil 28 on the outer surface of each nose 18 as the noses 18 pass one another in the generally arcing motion 50 as shown in FIG. 5, and in a juxtapose position. The opposing noses 18 swinging in the arc 50 toward one another allows an easy thumb 38 and finger 40 pressure on the opposing platforms 48 behind each prong 16 and nose 18 to place a leveraged pressure on axially separating adjacent spring coil ring strips 28 of the spring coil key ring 34 as shown by the arrows in FIG. 2. The levering action of opposing noses 18 is not accomplished by any prior art tools, which essentially jam a single wedge or point between adjacent coils 28 to axially move the coils 28 apart to insert or remove a key 36.

FIGS. 1-4 show two pair of opposing members 12 with each pair of opposing members 12 spaced apart a predetermined distance from the other pair of opposing members 12 to maximize the effectiveness of axially separating the spring steel coil ring strips 28 of the key ring 34 from one another when inserting and removing the keys 36 from the spring coil key ring 34. The two pair of opposing members 12 have the platforms 48 connected perpendicular to the arcing motion across the tops of the two spaced apart pair of opposing member 12 in which each pair of opposing members having their jaw in an open position creating an opening of a predetermined distance between the end points or teeth 20 for inserting spring coil key ring therebetween. which provides the previously stated mechanical leverage that makes it easy for the operator to open the spring steel key ring strips 34 by inserting the end points 20 of the hooked prongs 16 between the adjacent spring coil ring strips 28 to axially spread them apart from each other the predetermined distance for insertion and removal of the keys 36. The ends of the pairs of the spaced apart members 12 are hinged together at their other ends 22 by a common pivot pin 24.

With regard to the key ring opener 10 of the present invention, the opposing prongs 16, nose 18, points 20 and platforms 48 with its outer covers 44 are made of such materials as metals, nylon, hardened plastic or other suitable materials that are able to axially separate the spring coil rings 28 that are generally made out of steel or other suitable and durable metal or material requiring a substantial force to separate each adjacent coil 28 from the other to insert a key 36 or the like onto the key chain 34.

FIGS. 1-5 and 9 show a spring biased key ring opener 10 that keeps each opposing hooked prong 16 and its nose 18 spaced apart a predetermined distance from the other for easy use by a service station or dealership personnel charged with separating many keys from car key rings. In addition, valets at restaurants who handled hundred of cars in an evening of dining where the customers only want to leave the ignition key with the valet service and to take off the house and even the trunk key, which often contains stored goods from shopping or other valuables, is in need of the present invention to make their jobs easier in removing and reinserting keys on the typical spring steel key ring chain.

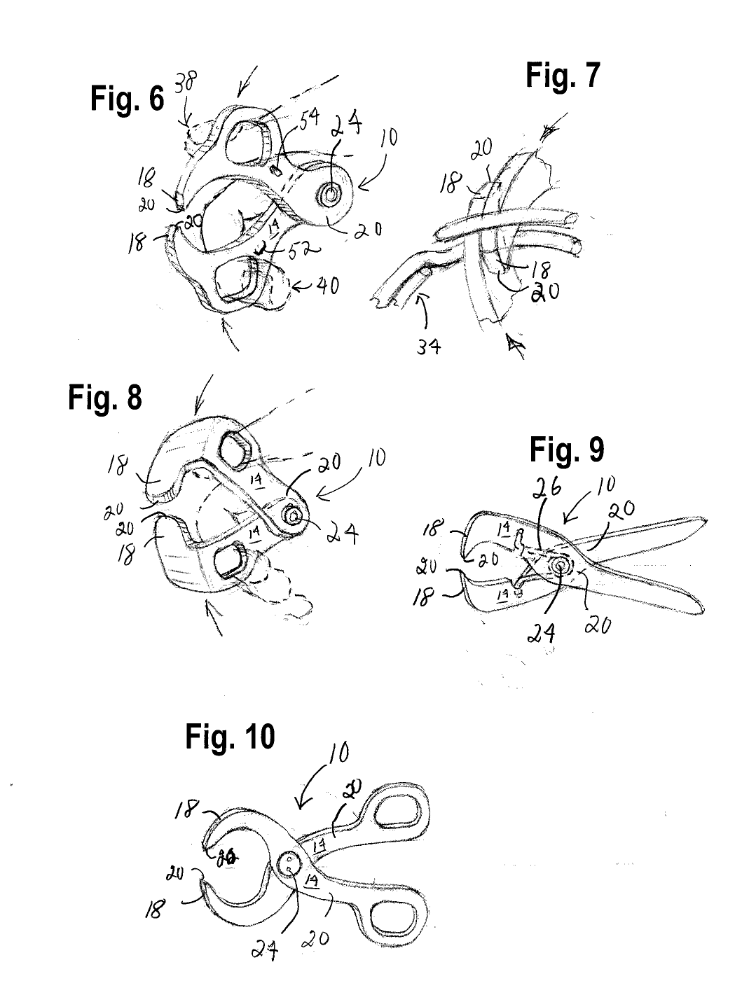

FIGS. 6 and 8 shows the insertion of the thumb 38 and at least one digit 40 into holes 52 on opposing hooked prongs 16 of FIGS. 6 and 8 to open the hooked prongs 16 and their points 20 to engage the spring coils 28 for axially separating them on a key ring chain 34. Note also that the openers in FIGS. 6-10 are all just a single pair of opposing members 12 unlike the openers 10 of FIGS. 1-4, which are two pair of opposing members 12 spaced apart a predetermined distance from one another. In addition, FIG. 6 shows a nib 50 and a detent 52 that are aligned on each opposing member 12 to engage each other when operating the tool to its closed position to hold each opposing member in a fixed closed position for the tool for carrying the tool in an end users pocket or for storage purposes.

In addition, the opener 10 is able to be made out of a single piece of spring metal that general is in the same configuration the previously describe opener 10 in which the two members 12 are held apart by the naturally memory of the spring metal. Here as in the other openers 10 an important feature is the opposing hooked prongs 16 that end in a similar rounded off opposing noses 18 and points 20 that are spaced apart a predetermined arcing distance from one another to protect the end user from jabbing themselves with a sharp point to engage the spring coils 28 that are often found in prior art key ring openers.

Another embodiment as shown in FIGS. 6 and 8, an opener 10 in which the prongs 16 are in a bias closed position without the spring 26 as shown in FIGS. 1 and 9 keeping the opposing points 20 opened a predetermined space, provides for storage or carrying in an end user's pocket. Each hooked prong 16 or nose 18 includes indentations or holes 52 near the end of each nose 18 such that the operator can grip the sides of the opener 10 with a thumb 38 and a digit 40 to open the jaws formed by the two hooked prongs 16 and their respective noses 18 and points 20. Then when the opposing points 20 are closed like a jaw between adjacent coils 28 like previously described, the spring coil rings 28 are axially separated from one another to insert or remove a key 36 on the spring coil key ring 34.

Also, the outer cover of the platform 48 on the backside of each hooked prong 16 and nose 18 may be integral with the material of the hooked prong 16 and nose 18 or a separate material like plastic or the like mounted onto the backside 46 of the hooked prong 16 and nose 18. In short, the present invention easily opens expandable coil type key rings 34 having a circular coil 28 with strip ends that partially over lap one another to allow the insertion or removal of keys and remote actuators for vehicles without causing damage or injury to the keys 36 or to the person's hand 42, fingers 40 and thumb 38 doing the insertion or removal. The upper and lower opposing members 12 and their respective hooked prongs 16 and noses 18 are generally made of metal and connected to each other by a typical hinged pin 24. The outer coverings 44 of the opposing platforms 48 for placing a person's finger 40 thereon are generally made of plastic, rubber or metal in an array of pleasing colors. But the important thing is the leverage that this key ring opening tool 10 of the present invention gives the person operating it whether the key ring opener 10 is biased open with the spring 26 in FIGS. 1-5 and FIG. 9 or generally bias closed as shown and described for the opener 10 in FIG. 6-8 and FIG. 10. With just minor effort on the part of the end user, the key ring coil strips 28 are axially separated and held open without great effort on the end user's part while the keys 36 and the remote car fob (not shown) are removed without injuring a finger nail, finger or hand.

Turning now to FIGS. 9 and 10, opposing members 12 extend rearwardly to their respective hinged pins 24 and then continue to extend rearwardly beyond the hinged pins 24 to form handles out of the other ends 22 for getting even greater mechanical leverage to open spring coil key rings 34. The portions of the these openers 10 engaging the adjacent spring coil ring strips 28 of the typical spring key ring chains 34 are essentially the same as the previously described components of the other key ring openers 10 of FIGS. 1-4 and 6-8 with the hooked prongs 16 and rounded noses 18 ending in points 20 for insertion between adjacent spring coils 28 of a spring coil key chain 34.

Having described and illustrated the principles of the invention in preferred embodiments thereof, it should be apparent that the invention can be modified in arrangement and detail without departing from the spirit and scope of the invention as claimed.

1. A key ring tool, comprising:
a first member having an oblong shape ending in a prong or jaw with a generally rounded nose; a second member having an oblong shape ending in a prong or jaw with a generally rounded nose or teeth, said first and second members having a hinged and rotatably connection therebetween at the other end of their oblong shape to form a jaw with the rounded noses or teeth for inserting the jaw between two adjacent coil ring strips of an expandable coil type key ring for axially separating the coil strips a predetermined distant apart from one another for the insertion or removal of a key or remote car fob.

2. The key ring tool of claim 1, wherein the hinged and rotatably connection is made with a pin connecting the first to the second member at the end of each member opposite the prong and its nose.

3. The key ring of claim 1, wherein the first and second member are made from metal, nylon, hardened plastic or other suitable material capable of separating the coil strips of the key ring.

4. The key ring tool of claim 1, wherein the noses on the opposing prongs forming the jaw where the noses arc pass one another in a close juxtaposition when passing through and between the adjacent coil ring strips of the key ring and wherein one coil ring strip on the underside of its nose is separated axially from the other adjacent coil ring strip in the direction of the hinged point between the first and second members.

5. A key ring opener, comprising:
a pair of opposing prongs having inwardly extending rounded noses in a predetermined spaced apart relationship to one another to form a coil key ring opening jaw at one end thereof; and
a pivot point connecting the pair of prongs at the other end to form a rotatably connection therebetween wherein the opposing noses in the jaw are wedged between overlapping and adjacent coil ring strips on opposing sides of the coil key ring to separate the adjacent coil strips axially from one another as the jaws are closed together and the opposing noses passing one another in a coincidental arc and adjacent juxtaposition with respect to each other in order to open a space between one coil strip and the end of the other adjacent coil ring strip to insert and remove keys on the key ring.

6. The key ring opener of claim 5, wherein the opposing prongs and noses are made of metal and the pivot is created by a steel pin passing through the first and second members and is captured in the end opposite the jaw.

7. The key ring opener of claim 5, further comprising a surface covering platform attached to the backside of each opposing prongs for placing operator fingers and a thumb, respectively, thereon to close the jaws on the coil ring strips of the coil key ring and to exert a leveraged pressure for axially separating the adjacent coil ring strips a predetermined distance from one another for insertion and removal of keys on the spring coil key ring.

8. A key ring tool with at least two opposing members spaced apart a predetermined distance from each other at one end and rotatably attached to each other at the other end to avoid sharp edges that injury the user's hand or fingers during operation yet is capable of being stored in a pocket without poking the end user or damaging the pocket having a mechanical leverage advantage for using on an expandable coil-type key ring having adjacent ring coil strips to connect and disconnect keys to and from an open end of a coil key ring by separating the adjacent coil ring strips thereon, comprising:
a hooked prong on each opposing member having a generally rounded nose with an end point curved inwardly for engaging the end point of one opposing member between an outer circumferences of adjacent coil ring strips and for engaging the end point of the other opposing member between an inner circumference of adjacent coil ring strips so that finger pressure upon each opposing hooked prong causes the end points on each nose of the prongs to rotate in an arc toward and then pass each other in a predetermined juxtaposed position with respect to each other for forcing an axial separation of adjacent coil strips from one another so that an end of one ring coil strip is axially separated sufficiently from the other adjacent ring coil strip to insert or remove a key therefrom;
a pin fixedly attaching and passing through the other end of each opposing member to form a rotatable connection therebetween; and
wherein the end points on the nose of each opposing member are capable of being placed anywhere along the outer and inner circumference between the adjacent ring coil strips to assist the movement and then either removal or insertion of keys on said coil key ring.

9. A key ring tool according to claim 8 wherein said hooked prong with its nose forms a pincer for separating said strips of the key ring coil as each member of the pincer is passed between the adjacent coil strips and said tool further including a nib on one opposing member and a detent on the other opposing member, which are positioned such to engage one another for holding each member in a predetermined juxtapositional configuration for storage or carrying in a pocket.

10. A key ring tool according to claim 8 wherein each of said hooked prongs include openings passing through each prong a predetermined distance rearwardly of the end point so that an end user inserts a digit and thumb through said openings to operate the tool and engage the end points against the coil strips of the key ring in order to axially separate the adjacent coils from each other.

11. A key ring tool according to claim 8 wherein said hooked opposing prongs are generally a flat opposing member of a predetermined thickness that extend outwardly from the pin a predetermined length to form a generally L-shaped leg having an opening therethrough on a first length of the L-shape portion attached to the pin for insertion of an operators digit and thumb to rotatably operate the tool and then a second length of the L-shape portion turns at a right angle to the first length and extends a predetermined length before ending in said nose at a right angle to the second length with a rounded end point for engaging adjacent ring coil strips.

12. A key ring tool according to claim 8 wherein the other end of the opposing members with the pin connection extend a predetermined distance beyond the pin connection to form a pair of handles of a pincer device to operate the end points on each nose into engagement with the adjacent ring coil strips to axially separate the strips from each other.

13. A key ring tool according to claim 8 wherein said generally rounded noses are generally elongate and tapers inwardly towards its distal end points.

14. A key ring tool according to claim 12 wherein said handles include opening therethrough for insertion of digits and a thumb to open and shut the point ends forming the pincer action to separate the adjacent ring coil strips for insertion and removal of keys.

15. A key ring tool according to claim 8 wherein said hooked prongs of each opposing member includes platforms affixedly attached to a backside of each prong for placing the digits and thumb on opposing prongs to push each prong toward each other and against adjacent coil ring strips to axially separate the adjacent coil ring strips with the least amount of effort.

16. A key ring tool according to claim 8 wherein said prongs form a jaw like action that clamps down on the coil ring strips on the inner and outer surface between the coil ring strips to axially separate them from each other.

17. A key ring tool according to claim 8 wherein said prongs and each rounded nose with the end points are biased apart from each other a predetermined distance by a spring located around the pivot pin and having spring parts bearing against the underside of each prong.

18. A key ring according to claim 8 wherein each opposing member, hooked prong and nose are an integral formed, one-piece construction of the same material.

19. A key ring tool having at least two opposing members pivotally connected to each other at one end and coming together in a coincidental arcing motion to form a jaw with at least two inwardly facing and rounded teeth for insertion on opposing sides between adjacent ring coil strips on a ring key chain to axially separate the adjacent coil ring strips when the jaw clamps down on opposite sides of the coil ring strips and the teeth close and then pass each other in an adjacent juxtapositional relationship as the coil rings separate wherein keys are either inserted or removed from the key ring.

20. A key ring tool according to claim 19 wherein said teeth on the jaw have rounded ends that close against the key ring coils between the adjacent coil ring strips allowing a variable axially displacement to continuously increase the space of the coil ring strips apart from each other until the jaw is in its furthest closed position to effect greater room between adjacent coil ring strips to easily remove larger key heads from the key ring.
